(19) United States
(12) Patent Application Publication
(10) Pub. No.: US 2009/0133279 A1
(43) Pub. Date: May 28, 2009

(54) Shingle hanging tool

(76) Inventors: William J. Gorman, South Hamilton, MA (US); David Weller, Vinalhaven, ME (US)

Correspondence Address: William J Gorman, 62 Lakeshore Drive, South Hamilton, MA, 01982, US

(21) Appl. No.: 12/291,732

(22) Filed: Nov. 14, 2008

Related U.S. Application Data
(60) Provisional application No. 61/003,511, filed on Nov. 19, 2007.

(51) Int. Cl. G01B 1/00; G01B 5/16

(52) U.S. Cl. 33/648

(57) ABSTRACT

A tool is disclosed for alignment of siding and roofing materials including but not limited to shingles. The tool includes a means of affixing a ledger board of other guidance or measurement device. The tool may include a gradicule for measurement to a reference line. This tool allows the use of a ledger board without compromising the integrity of the shingles.

### BACKGROUND

When a carpenter is placing shingle on a house it is important to align the shingles evenly and with the correct spacing. A common practice is to employ a ledger board as an aid. The ledger board is nailed to the wall to provide a lip to place the next layer on and to ensure proper alignment. This ledger board technique requires nailing the ledger board onto the existing course of shingles thereby compromising the integrity of the shingles.

A tool is disclosed for alignment of siding and roofing materials including but not limited to shingles. The tool includes a means of affixing a ledger board or other guidance or measurement device. The tool may include a gradicule for measurement to a reference line. This tool allows the use of a ledger board without compromising the integrity of the shingles.

### BRIEF DESCRIPTION OF THE FIGURES

FIG. 1 is a front and side view of the device.

### DETAILED DESCRIPTION OF PREFERRED EMBODIMENTS

For the purposes of promoting an understanding of the principles of the invention, reference will be made to the embodiments illustrated in the drawings and specific language will be used to describe the same. It will nevertheless be understood that no limitation of the scope of the invention is hereby intended. Any such alterations further modifications in the illustrated devices, any such further applications of the principles of the invention as illustrated herein are contemplated as would normally occur to one skilled in the at to which the invention relates.

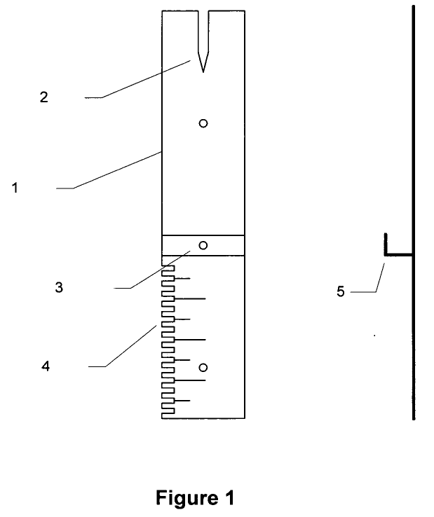

FIG. 1 depicts an embodiment of the tool 1. This device includes a notch 2, engagement means 5, a gradicule 4 and an opening 3.

In this configuration the device may be affixed to the surface of a wall or roof using a nail. The nail is driven through the notch 2 and the head of the nail holds the tool 1 in position. A set of tools 1 are placed on the wall or roof, spaced at an appropriate distance to hold a ledger board horizontally in the engagement means 5.

The ledger board may be affixed to the tool 1 with a faster driven through opening 3. If used in this way the tools 1 may be used in pairs or sets of two or more depending upon the weight and length of the ledger board and the shingle materials.

After the ledger board is held in the desired location the siding or shingles may be affixed to the wall. The siding will cover the upper section of the tool 1 that extends beyond the ledger board including the notch 2. After the siding is affixed to the wall the tool 1 and ledger board may be removed by tapping downward on the tool, thereby allowing the nail head holding the tool 1 to slide along the notch 2 and free the tool 1. This invention allows the tool to be removed leaving no holes in the new siding.

The tool may be provided with a gradicule 4. The gradicule 4 allows easy and repeatable placement at the correct height from course to course of shingles. This gradicule 4 reduces the need to measure between courses and thereby simplifies the shingling process. The gradicule may be offered on one or more of the set of tools needed for the shingling operation.

### SUMMARY OF THE INVENTION

It is an object of this invention to retain to the greatest possible extent the advantages using a ledger board without the need for compromising the siding with holes or markings resulting from affixing the ledger board to the surface of the newly installed siding. With the use of this invention the nails or screws used to hold the ledger board remain above the new layer of siding where they do not detract from the ascetics or the integrity of the new wall siding.

Another object of this invention is to provide a gradicule that will speed and improve accuracy of placing a ledger board to facilitate faster and better quality siding installations.

When a carpenter is placing shingle on a house it is important to align the shingles evenly and with the correct spacing. A common practice is to employ a ledger board as an aid. The ledger board is nailed to the wall to provide a lip to place the next layer on and to ensure proper alignment. This ledger board technique requires nailing the ledger board onto the existing course of shingles thereby compromising the integrity of the shingles.

A tool is disclosed for alignment of siding and roofing materials including but not limited to shingles. The tool includes a means of affixing a ledger board or other guidance or measurement device. The tool may include a gradicule for measurement to a reference line. This tool allows the use of a ledger board without compromising the integrity of the new shingles.

In the preferred embodiment the tool if formed of sheet metal. The tool include a flange protrusion to hold a ledger board. A ledger board is attached to the flange with a nail or screw placed through the hole provided. Two such tools are used in a pair, one at each end of the ledger board.

The ledger board is aligned with a preexisting course of shingle and the correct spacing is attained before the tool is secured to the wall with a nail. A gradicule is provided to aid in the correct spacing between courses. The securing nail is placed into the V-notch at the top of each tool.

The new course of shingles is laid above the ledger board and covering the top of the tool. After the course of shingles is laid, the tools and attached ledger board is removed by a sharp tap downwards that allows the securing nail to slide off via the v-notch. The securing nails are left under the newly laid course of shingles.

The v-notch and resulting removal method is an advancement over a common ledger board in that the nails used to secure the ledger board are hidden under the layers of shingles as the siding progresses up the wall. The new layers of siding are left uncompromised by nail holes.

This tool allows faster and more accurate shingling while proving a more weather tight final product (no holes exposed).

It is obvious to those practiced in the art that this tool can be manufactured of plastic, metal or a combination of materials.

Further embodiments include inexpensive versions without the gradicule and disposable versions that can be left partially in place or discarded when the course is finished.

Further embodiments include clamping means for attaching the tool to the ledger board.

This tool and ledger board combination can be used on house siding and roofing. In addition to traditional shingles, the tool may be useful for vinyl siding, roll roofing, tiles and other wall coverings both inside and outside of the structure.

It is understood that other embodiments can be fabricated and come within the spirit and scope of these claims.

We claim:

1. A tool that includes an engagement means for attachment of a ledger board and a groove at the top for affixing the device to the substrate to be sided and were the groove is shaped to allow removal from under the siding after the siding has been installed on the substrate.

2. A device as in claim 1 where the groove has a v-shaped section.

3. A device as in claim 1 where the groove is sized for a nail.

4. A device as in claim 1 that is made of sheet metal, plastic or a combination thereof.

5. A device as in claim 1 were the engagement means is a flange.

6. A device as in claim 5 were the flange includes an opening for a fastener to hold the ledger board.

7. A device as in claim 1 were the ledger board is a horizontal alignment device made of metal or plastic.

8. A device as in claim 1 that includes a leveling device.

9. A device as in claim 1 that includes an adjustable stop to aid in correct placement relative to a lower layer of siding.

10. A device as in claim 1 that can be used for any of the following: siding, roofing, rolled materials, tiles, decorative elements, paint, insulation, plumbing.

11. A device as in claim 1 that includes a measurement scale or gradicule to aid in correct placement relative to a lower layer of siding.

12. A device as in claim 11 where the measurement scale is attached to the lower portion of the device.

13. A device as in claim 11 where the measurement scale is adjustable.

14. A device as in claim 11 were the measurement scale is attached, etched, printed or is a printed label.
